(19) United States
(12) Patent Application Publication
(10) Pub. No.: US 2005/0281982 A1
(43) Pub. Date: Dec. 22, 2005

(54) Template

(75) Inventor: Shunpu Li, Cambridge (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ingenia Technology Ltd

(21) Appl. No.: 10/534,931

(22) PCT Filed: Nov. 12, 2003
(86) PCT No.: PCT/GB03/04911

§ 371 Date: May 13, 2005

(30) Foreign Application Priority Data
Nov. 29, 2002 (GB) 02279024

(51) Int. Cl. B05D 3/02; B05D 1/40; B32B 3/30

(52) U.S. Cl. 428/141; 427/384; 427/331; 428/167; 428/446; 428/522; 428/337

(57) ABSTRACT

A template is formed from a layered structure comprising a substrate and a single-phase polymer layer positioned on the substrate. The polymer layer comprises a textured surface, the texturing being caused by induction of stress in the polymer layer. The template finds use in the manufacture of a structure on the nanometre scale, which comprises the steps of providing a template and molding a material on to the template, followed by removal of the molded material from the template to provide a structure on the nanometre scale, such as an array, a grid, an optical device or an electronic device. The template may be made by a method comprising the steps of depositing a layer of a single-, phase polymer on to a substrate, baking the resulting structure at a temperature below the glass transition temperature (T_{g}) of the single-phase polymer, texturing a surface of the polymer layer by inducing stress in the polymer layer and annealing the resulting structure to provide a template.

The present invention relates to a template for use in the manufacture of structures on the nanometre scale.

The provision of templates for use in the production of structures on the nanometre scale and, in particular, the provision of templates to produce very detailed and intricately patterned structures is very difficult.

According to the present invention, a template is provided which is formed from a layered structure comprising a substrate and a single-phase polymer layer positioned on the substrate, wherein the polymer layer comprises a textured surface, the texturing being caused by induction of stress in the polymer layer.

According to the present invention, a method of manufacture of a structure on the nanometre scale comprises the steps of providing a template as defined above, molding a material on to the template and removing the molded material from the template to provide the desired structure.

According to the present invention, a method of making a template comprises the steps of depositing a layer of a single-phase polymer on to a substrate, baking the resulting structure from the deposition step at a temperature below the glass transition temperature (T_{g}) of the single-phase polymer, texturing a surface of the polymer layer by inducing stress in the polymer layer and annealing the resulting structure from the stress-induction step to provide a template.

The present invention therefore surprisingly utilises the fine structures generated by topographic instabilities in single-phase polymer films, and thus enables the production of highly intricate, organised structures on the nanometre scale, so-called “nanostructures”.

The method of making a template according to the present invention provides a simple, fast and effective way of producing a template, which may then be used in the production of nanostructures for use in a variety of applications. Patterning of the template may be controlled by optimisation of the fabrication parameters, for example the temperature or polymer film thickness employed.

The template of the invention may be used in the manufacture of a variety of nanostructures such as arrays, grids and electronic or optical devices such as polarisers. Such structures have many, applications not only in the fields of optics and electronics but also, for instance, in molecular separation techniques, for example the separation of DNA. Also, unlike processes which involve the use of patterned substrates, the method of manufacture of the invention does not employ lithography and therefore provides a new avenue for the fabrication of nanostructures.

The substrate comprised in the template of the invention is preferably inorganic and more preferably comprises silicon. The thickness of the substrate will typically be approximately 0.5 mm.

Any single-phase polymer may be comprised in the template of invention, however, the single-phase polymer is preferably selected from polymethylglutarimide (PMGI), polymethylmethacrylate (PMMA) and photoresists, such as AZ5214E, which is manufactured by Clarland GmbH and comprises 2-methoxy-1-methylethylacetate as its main component. More preferably, the single-phase polymer is PMGI. The thickness of the single-phase polymer layer may vary depending on the intricacy of the desired texturing or patterning of the template, however, it is typically in the range 50-300 nm.

The template may additionally comprise a thin, rigid layer comprising a semiconductor or a metal for example. This layer is positioned on the single-phase polymer layer and will typically have a thickness of approximately 10 nm. If the template comprises a semiconductor layer, the semiconductor will preferably be germanium, which is favourable for further pattern transformation.

In the method of making a template according to the invention, the layer of single-phase polymer may be deposited on to the substrate by any conventional method such as coating, painting or spraying for example. The resulting structure is then baked at a temperature below the glass transition temperature (T_{g}) of the single-phase polymer such that a degree of instability remains in the polymer to form a firm but flexible film on top of the substrate. If a baking temperature of higher than the T_{g} of the polymer is employed, no instability remains in the polymer. If the single-phase polymer is PMGI, which has a T_{g} of approximately 200° C., a temperature of less than 200° C. will therefore typically be employed. Preferably the temperature of this baking step is in the range 120-200° C.

A semiconductor layer may also be deposited on to the single-phase polymer layer. In this embodiment of the method according to the invention, the semiconductor layer may be deposited on to the polymer layer by any conventional method such as sputtering. The semiconductor layer is preferably applied to a structure comprising a substrate coated with a single-phase polymer layer which has preferably already been subjected to a baking step at a temperature of below the T_{g} of the polymer. Following deposition of the semiconductor layer on to the polymer layer of such a structure, the resulting three-layer structure is then subjected to a further baking step again at a temperature of below the T_{g} of the polymer layer.

A surface of the polymer layer is textured via induction of stress into the polymer layer. The stress induced in the polymer is typically in the range 0.5-1 MPa.

The nature of the texture or pattern so-produced is highly dependent on the applied stress, which can be applied such that highly organised and complicated patterns are achieved. For example, if a tensile or compressive strength is applied, a lined pattern in the direction of the stress will be generated in the surface of the polymer layer. Preferably, stress-induction in the polymer layer results in the formation of parallel grooves in the surface of the polymer layer. These parallel grooves are created because, under stress, the formation of waves with a vector in the stress direction becomes energetically unfavourable thus producing periodically ordered structures in the surface of the polymer layer. This idea is analogous to pulling a wrinkled table cloth in opposite directions. The polymer film thus provides a uniform striped pattern with a characteristic wavelength (λ) as the instability in the polymer layer is controlled by spinodal dewetting, ie. the dewetted wave structure is characterised by a single wavelength.

One way in which stress may be induced in the polymer layer is via the use of a load bearing member comprising at least one contact surface which engages the surface to be textured. The load bearing member employed in this embodiment of the method of the invention may comprise polydimethylsiloxane (PDMS), and typically has the shape of a truncated prism. The contact surface of the load bearing member may be smooth or may itself be textured.

The template of the invention is employed in the manufacture of structures on the nanometre scale, which are typically made from materials such as metals, alloys, ceramics and polymers.

The structures so-produced may include arrays, grids, electronic devices and optical devices, such as polarisers. Of particular interest are magnetic wire arrays, such as those comprising Permalloy (Ni₈₀Fe₂₀) which may be used in device applications.

The present invention will now be described with reference to the following examples and to the accompanying drawings. In the drawings:

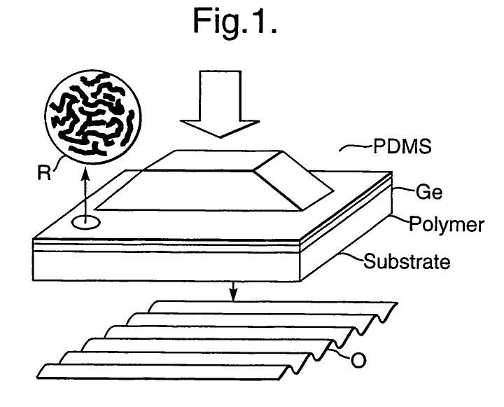

FIG. 1 is a side perspective view illustrating the stress-induction step of the method of making a template according to the present invention, including an enlarged detail of a textured surface of the template of the invention;

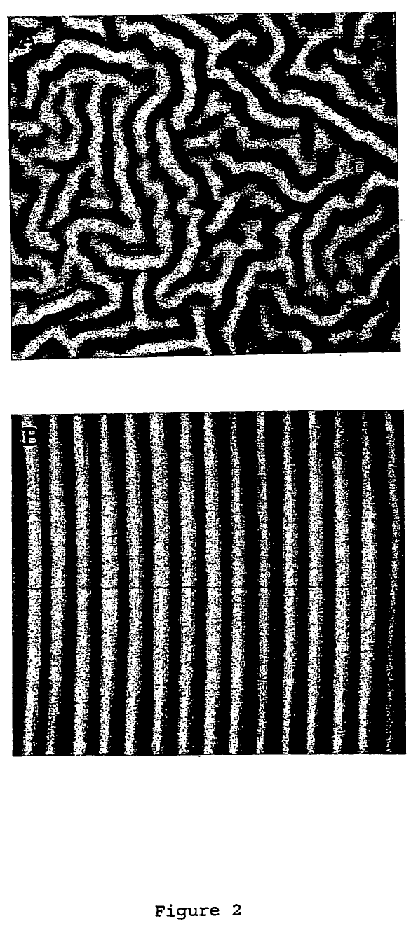

FIG. 2 shows atomic force microscope (ASM) images of (A) a randomly textured surface taken from a 150 nm thickness PMGI film following baking at 160° C., and (B) an ordered surface resulting from stress-induction in a 250 nm thickness PMGI film following baking at 160° C.;

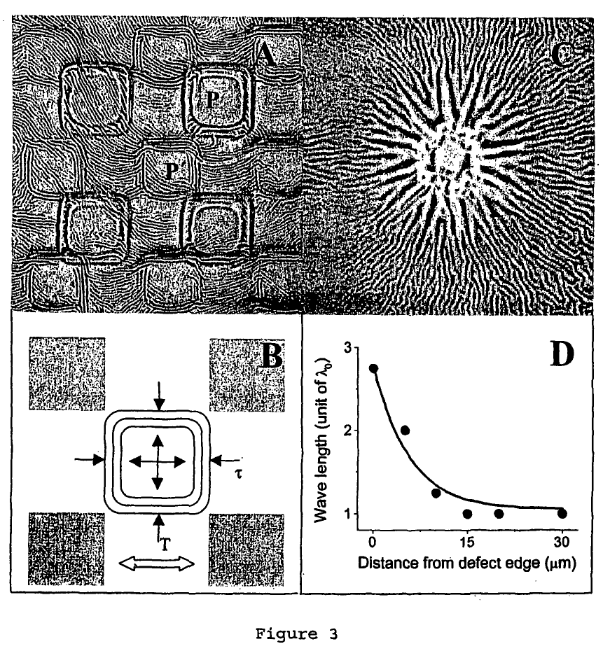

FIG. 3 illustrates surface patterns induced by localised stress and the analysis thereof. (A) shows a surface structure obtained by pressing a sample surface using a PDMS load bearing member which is patterned with 20 μm square anti-dot patterns; (B) is a schematic illustration of the local stress distribution in sample A in which, for simplicity, only important stress components, τ are shown; (C) shows a defect-induced structure ordering; (D) illustrates the distance dependence of the wavelength in the vicinity of the defect;

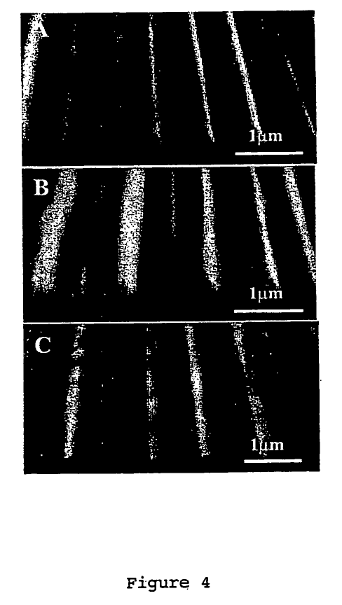

FIG. 4 shows modulated wire patterns obtained by surface wave interference, as follows: (A) a uniform pattern (φ₁) aligned at 160° C.; (B) a double-line pattern observed after heating sample with structure shown in (A) for 10 min at 205° C.; and (C) a single/double-line modulated pattern obtained after heating the sample shown in (A) to 190° C. for 10 min.

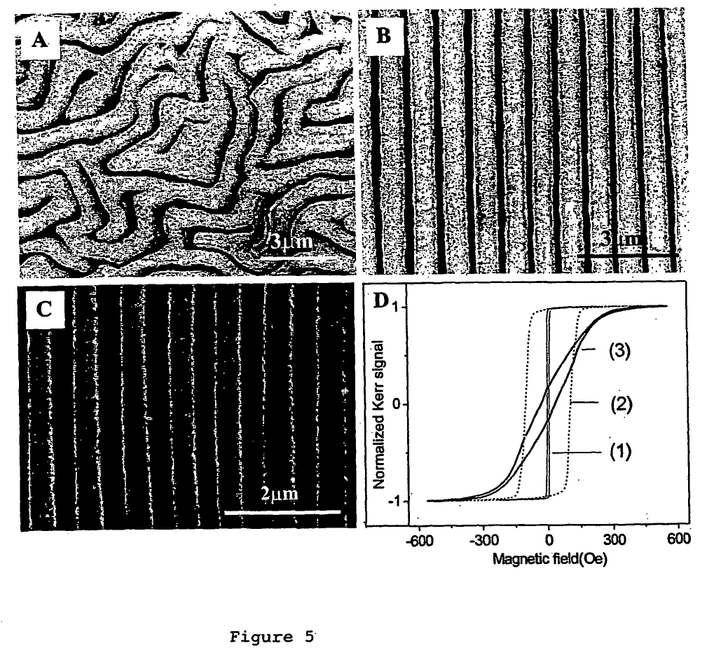

FIG. 5 shows scanning electron miscroscopy (SEM) images of the fabricated structures and magnetization reversal measurement of the superalloy wires, as follows: (A) and (B) are two PMGI polymer structures (random and aligned, respectively) defined by sequential plasma etching, in which nanochannels were etched to the silicon substrate; (C) shows a Permalloy wire array obtained by lift-off; (D) illustrates magnetic hysterisis loops measured on 400 nm width and 30 nm thick Permalloy wire arrays, in which loop 1 was taken from an unpatterned film and loops 2 and 3 were taken when the magnetic field was applied along and perpendicular to the wire axis respectively.

### EXAMPLE 1

### Formation of a Template Using a Load Member with a Smooth Contact Surface

250 nm and 150 nm thick layers of PMGI (Micro Chem Corp., PMGI SF6) were spin-coated separately on to silicon substrates and baked at 170° C. for 30 min. Then 10 nm-thick germanium was deposited on to the PMGI layers by sputtering. Random wave patterns were observed when heating the samples above 130° C., which is well below the T_{g} of pure PMGI (approximately 200° C.).

A PDMS elastic truncated prism with a smooth contact surface was pressed on to each sample surface as shown in FIG. 1. This Figure shows that when pressure was applied to the PDMS prism, the intended lateral expansion of the PDMS prism generated a stress along the film plane and rendered the assembled surface structure ordered (panel O), while on the free sample surface random wave patterns were formed (panel R).

The atomic force microscope (AFM) images of the two sample surfaces after heating at 160° C. for 25 min are shown in FIG. 2. FIG. 2A shows a 150 nm thickness film with a free surface, which comprises random waves, while in the case of an applied load to the 250 nm thickness film, the waves are well ordered as shown in FIG. 2B. The area of the ordered structure can extend over the whole sample (centimetre scale) with millimetre size domains induced by non-uniform deformation of the PDMS prism.

In this example, the applied load was 0.5-1 MPa. A similar order of lateral expansion stress within the sample surface is expected because of the high Poisson's ratio of the PDMS. The mechanism of wave formation is based on the stress assisted dewetting of the polymer film involved, which is fundamentally different from those of other observed wave structures, such as mechanical compression induced surface buckles. After removal of the applied load the sample was annealed at 160° C. for ten hours and the ordered structure remained stable.

### EXAMPLE 2

### Formation of a Template Using a Load Member with a Patterned Contact Surface

A load member comprising a patterned contact surface was formed by casting PDMS against a 1.5 μm thick patterned photoresist layer. The resulting PDMS structure was cut into a rectangular shape to provide a PDMS load member patterned with a 20 μm square anti-dot pattern.

This member was pressed into a germanium-capped PMGI film at 160° C. for 25 min. As the PMGI film was elastic, there were clear traces of the PDMS patterns printed on the sample surfaces, as indicated by the letter P in FIG. 3A. In addition to these patterns, a new set of square patterns (as indicated by P′) was formed, which appeared as a copy of the initial PDMS pattern.

This additional formed patterning may be explained as follows. When the PDMS was compressed on the sample surface, the regions between holes started to expand as shown in FIG. 3B. The five typical expanding parts (the centre and four arms of a cross as indicated) generated a compressive strain in a square-framed region thus aligning the patterns along the frame. The asymmetry of the alignment of ripples is attributed to the existence of an off-normal force applied to the PDMS, which generates a tension along the horizontal direction, as shown by the open arrow in FIG. 3B.

In general, the value of applied stress is expected to be much smaller than the internal stress of a film, which is responsible for the film instability. The external stress is used merely to suppress the structural disorder induced by thermal fluctuation and to align the wavelike patterns. The internal stress, which causes film instability, is accumulated due to the temperature rise during annealing and can be expressed as:

$${σ}_{0} = {\int }_{{T}_{0}}^{T} \frac{{E}_{c}}{1 - {v}_{c}} ( {α}_{p} - {α}_{c} ) ⅆ T \qquad ( 1 )$$

where T₀ and T are, respectively, the stress free temperature and the temperature to which the film is heated, E_{c} is the Young's modulus and ν_{c} the Poission's ratio of the germanium film, and α_{c} (αₚ) is the thermal expansion coefficient of the polymer film. For a PMGI film without a germanium capping layer no instability is found and the substrate effect can therefore be neglected. It is difficult to calculate the value of σ₀ precisely since the value of αₚ depends strongly on the temperature and an additional polymerized layer could form at the interface between the polymer and the capping (germanium) layers. However, a reasonable estimate gives σ₀ of approximately 100 MPa, based on E_{c}/(1−v_{c})˜10¹¹ Pa and (αₚ−α_{c}) (T−Tₒ)˜10⁻³. This is about two orders higher than the applied stress. Thus, the applied stress only acts as a small perturbation to the isotropic internal stress σ₀ and introduces an anisotropy which leads the structure to order.

This can be further understood through the examination of the ordering of a local structure generated by a defect centre. FIG. 3C shows a typical structure at the vicinity of a defect on a load free sample. When a defect, for example a dust particle or pin hole, exists in a polymer film restrained by a capping (germanium) layer, the break of film continuity leads to a redistribution of stress inside the film. By expressing the radial and traverse components of the stress around the defect as σᵣ and σₜ, respectively, this gives:
σᵣ=σₒ(1−e^{-r/ξ}), (2a)
σₜ=σₒ(1−v_{c}e^{-r/ξ}), (2b)
where r is the radius calculated from the edge of the defect and ξ is a characteristic length of the stress distribution. For stress-assisted instability in a rubber-like polymer film, the relationship between the surface wavelength and stress is λ=K/σ², where K is a constant. Considering that the redistribution of material during formation of the wavelike structure is caused by the internal stress along the wave vector direction, it follows that:

$$λ = \frac{{λ}_{o}}{{( 1 - {ν}_{o} {ⅇ}^{- r / ζ} )}^{2}} \qquad ( 3 )$$

where λ₀ is the wave length of the structure far away from the defect centre. Taking ν_{c}=0.4, the characteristic length ξ was found to be about 10 μm by fitting equation (3) with experimental results as shown in FIG. 3D. If the radius of the whole ordered region is taken to be 20 μm (see FIG. 3C), a value of the stress anisotropy required for ordering the structures in a sample from equation (2) may be obtained as follows:

$$α = \frac{{σ}_{t} - {σ}_{r}}{{σ}_{t} + {σ}_{r}} ∼ 4 \% \qquad ( 4 )$$

This result confirms that a small perturbation in the stress can dramatically modify the structure morphology.

### EXAMPLE 3

### Provision of Complex Patterning Via Changes in Experimental Conditions

This Example provides another method of making a template, the so-called “surface wave interference”, to create more complex patterns. The wavelength of surface patterns is normally determined by the fastest growing wave mode in the system and strongly depends on experimental parameters. If a wave pattern Φ₁ε₁₍ₜ₎ₑ^{iq}^{₁}^{x} is the characteristic mode in a given experimental condition, a rapid change of the sample condition will create a new characteristic wave Φ₂=ε₂(t)e^{i(q}^{₂}^{x+φ)}. In the time period when the decaying wave Φ₁ and arising wave Φ₂ co-exist a new pattern induced by their interference is observed.

FIG. 4A shows an aligned wave Φ₁ created at 160° C. and FIG. 4B shows a double line pattern obtained after further heating the sample for 10 min at 205° C. without the application of a load. This example shows that the dominant surface wavelength of the film at 205° C. is about twice of that at 160° C. (q₂˜q₁/2) due to strong softening of the polymer near its glass transition point. FIG. 4B illustrates the pattern formed in a film which has not yet reached its steady state. This may be expressed as Φ=Φ₁+Φ₂=ε₁(t)e^{iq}^{₁}^{x}+ε₂(t)e^{i(q}^{₁}^{x/2+φ)}. The value of the phase shift φ is required for pattern symmetry. Similarly, the wavelength obtained at 190° C. is about 1.7 times of that obtained at 160° C. After heating the sample with wave Φ₁ to 190° C. for 10 min a single/double line modulated structure can be found, as shown in FIG. 4C, which agrees well with Φ′=Φ₁+Φ′₂=ε₁(t)e^{iq}^{₁}^{x}+ε′₂(t)e^{i(2q}^{₁}^{x/3)}

In order to utilise such an interference effect to create complex patterns, it would be ideal if the wavelengths of both Φ₁ and Φ₂ could be chosen as desired. There is no limit to the number of the waves which may be included, and the obtained wave (Φ₁+Φ₂) may further interfere with another wave Φ₃ to create more complex patterning, e.g. Φ=[(Φ₁+Φ₂)+Φ₃]+ . . . . Desired structures displaying abundant line arrangements with the appearance of bar-codes are possible. Such observed interference patterns and their evolution process are of use in the fundamental study of dynamic processes of polymer diffusion and creep, and wave mode selection due to film instability.

### EXAMPLE 4

### Fabrication of a Nanostructure

The wavelength of the lined patterns obtained in the above-described germanium-capped PMGI template was in the micron to submicron range, and their amplitude was around 20 nm.

A 40 nm thick PMMA (Micro Chem Corp. 950 PMMA A2) resist layer was spin-coated on to the template surface and the resulting structure was baked at 160° C. for 5 min before being cooled to room temperature. A glass wafer was employed to protect the surface flatness of the PMMA layer. After partially removing the PMMA layer by oxygen (O₂) plasma etching, the remaining PMMA in the trenches of the template was used as mask during etching of the thin germanium layer by sulphur hexafluoride (SF₆). Subsequently the patterned germanium layer was used as another mask during etching through the PMGI by O₂ plasma. Finally, a layer of functional material, such as metal, was deposited on to the structure and the desired nanostructures were obtained by lifting off the rest of the PMGI polymer.

By varying the parameters employed in the etching of the PMMA layer, the line width of the etched PMGI could be controlled. FIGS. 5A and 5B show, respectively, typical SEM images of random and ordered polymer structures on a silicon substrate after the final reactive ion etching (RIE). The channel width obtained was approximately 150 nm and the whole pattern was uniform and defect-free over a large area.

FIG. 5C shows a magnetic wire array of 30 nm thick Permalloy (Ni₈₀Fe₂₀) obtained in this way. In recent years, such fine patterned magnetic wires have attracted great scientific interest in particular in device applications. The magnetization reversal of fabricated permalloy wires were studied by the magneto-optic Kerr effect technique and the results are shown in FIG. 5D. Compared to the unpatterned film (loop 1), the large increase in the coercivity obtained with the field along the wire (loop 2) is attributed to the shape anisotropy induced complication of magnetization reversal, such as the so-called “bucking effect” etc. When the field was applied perpendicular to the wires, a remarkable increase in the saturation field was observed (loop 3). This could be explained by the “magnetic charges” induced along the wire edges, resulting a magnetically hard behaviour in the direction perpendicular to the wires.

1. A template formed from a layered structure comprising a substrate and a single-phase polymer layer positioned on the substrate, wherein the polymer layer comprises a textured surface, the texturing being caused by induction of stress in the polymer layer.

2. A template according to claim 1, additionally comprising a semiconductor layer positioned on the polymer layer.

3. A template according to claim 1, wherein the single-phase polymer is selected from polymethylglutarimide (PMGI), polymethylmethacrylate (PMMA) and photoresist AZ5214E.

4. A template according to claim 2, wherein the semiconductor is germanium.

5. A template according to claim 1, wherein the substrate comprises silicon.

6. A template according to claim 1, wherein the textured surface comprises parallel grooves.

7. A template according to claim 1, wherein the thickness of the single-phase polymer layer is 50-300 nm.

8. A template according to claim 2, wherein the thickness of the semiconductor layer is approximately 10 nm.

9. A method of manufacture of a structure on the nanometre scale comprising the steps of:
providing a template as defined in claim 1;
molding a material on to the template; and
removing the molded material from the template to provide a structure on the nanometre scale.

10. A method according to claim 9, wherein the structure is an array, a grid, an optical device or an electronic device.

11. A method according to claim 10, wherein the optical device is a polariser.

12. A method according to claim 10, wherein the array is a magnetic wire array.

13. A method according to claim 12, wherein the magnetic wire array comprises Permalloy.

14. A method of making a template comprising the steps of:
depositing a layer of a single-phase polymer on to a substrate;
baking the resulting structure from the deposition step at a temperature below the glass transition temperature (T_{g}) of the single-phase polymer;
texturing a surface of the polymer layer by inducing stress in the polymer layer; and
annealing the resulting structure from the stress-induction step to provide a template.

15. A method according to claim 14 additionally comprising the step of depositing a semiconductor layer on to the polymer layer.

16. A method according to claim 14, wherein the temperature employed in the baking step is in the range 120-200° C.

17. A method according to claim 14, wherein the stress induced in the polymer is in the range 0.5-1 MPa.

18. A method according to claim 14, wherein stress is induced in the polymer layer using a load bearing member comprising at least one contact surface engaging the surface to be textured.

19. A method according to claim 18, wherein the load bearing member comprises polydimethylsiloxane (PDMS).

20. A method according to claim 18, wherein the contact surface of the load bearing member is textured.

21. A method according to claim 14, wherein the single-phase polymer is selected from PMGI, PMMA and photoresist AZ5214E.

22. A method according to claim 15, wherein the semiconductor is germanium.

23. A method according to claim 14, wherein the substrate comprises silicon.

24. A method according to claim 14, wherein stress-induction in the polymer layer results in the formation of parallel grooves in the surface of the polymer layer.

25. A method according to claim 14, wherein the thickness of the polymer layer is 50-300 nm.

26. A method according to claim 15, wherein the thickness of the semiconductor layer is approximately 10 nm.
